(19) United States
(12) Patent Application Publication
(10) Pub. No.: US 2023/0136776 A1
(43) Pub. Date: May 4, 2023

(54) APPARATUS AND METHOD OF TREATING THE INTERNAL SURFACES OF A TIMBER BARREL WITH AN ABRASIVE

(71) Applicant: Barrel Rejuvenation Services Pty Ltd, Chandlers Hill (AU)

(72) Inventors: Jonathan Lindsay BLAKEMAN, Capel (AU); Kimberley John BUIST WALKER, Southbank (AU); Ronald John MCDONALD, Anglesea (AU)

(21) Appl. No.: 17/980,270

(22) Filed: Nov. 3, 2022

(30) Foreign Application Priority Data
Nov. 3, 2021 (AU) 2021903510

(51) Int. Cl. B24B 31/00; B24B 31/023; B24B 31/02

(52) U.S. Cl. CPC B24B 31/006; B24B 31/023; B24B 31/0224

(57) ABSTRACT

Apparatus 10 and method for cleaning, rejuvenating or treating the internal surfaces of a timber barrel 28 with an abrasive, the apparatus 10 comprising a clamping arrangement that includes at least one clamp 21-24 for clamping the barrel 28. The clamp 21-24 being rotatable to rotate the barrel 28 about its axis and the clamping arrangement being operable to tilt the axis of the barrel 28 during rotation through at least about 20°, preferably 25-40%, to either side of horizontal.

### PRIORITY CROSS-REFERENCE

The present application claims priority from Australian Provisional Patent Application No. 2021903510 filed 3 Nov. 2021 the contents of which is to be considered to be incorporated into this specification by this reference.

### TECHNICAL FIELD

The present invention relates to methods and apparatus for treating or rejuvenating the internal surfaces of timber barrels and the invention has been developed principally in relation to timber barrels as used in the wine and spirits industry for fermenting and aging wine or spirits prior to bottling. It will be convenient to describe the invention in relation to that specific application, however it is to be appreciated that the invention is not limited to wine/spirits barrels and thus it is envisaged that the invention could be applied to any timber barrel that requires internal surface rejuvenation.

### BACKGROUND OF INVENTION

The discussion of the background to the invention that follows is intended to facilitate an understanding of the invention. However, it should be appreciated that the discussion is not an acknowledgement or admission that any aspect of the discussion was part of the common general knowledge as at the priority date of the application.

Timber barrels are used in the alcohol industry to ferment, age and to alter the taste of various different alcoholic beverages. These kinds of barrels are also known as casks and so reference herein to barrels also encompasses casks. Different types of wine very commonly spends time in timber barrels, as does some whiskeys, brandy, rum, tequila, and various others. The type of timber used for different types of alcohol can vary depending on the flavours or characteristics (including colour) that is intended to be imparted or added to the liquid alcohol within the barrel, by contact between the liquid alcohol and the internal surface of the barrel. American oak and French oak are popular barrel timbers and each imparts or adds a different flavour or characteristic to the alcohol product.

Wines and other liquid alcohols can spend different amounts of time within a barrel depending on the flavour or characteristics to be imparted. Also, greater or more concentrated flavours and characteristics tend to be available with new barrels as compared to barrels that are being reused. However, for most producers, the use of new barrels exclusively is financially prohibitive and so barrels are reused, usually with lower cost product spending time in the reused barrels. A typical barrel used at the premium end of the wine industry has a life of about five years before the timber no longer imparts or adds as required to the wine product. This reduction in usefulness over time occurs at least partially as a result of a build-up of a lining or covering, typically formed by tartrates from the wine that deposit over the internal surface of the barrel, so that there is a loss of access to or contact with the internal surface of the barrel by the wine. As the build up of the lining or covering is gradual, this loss of access or contact can be tolerated until such time as the lining or covering becomes sufficiently complete across the internal surface of the barrel that any access or contact that is still available is nevertheless insufficient to impart or add the flavours and characteristics required. At that stage, the barrel is discarded.

Removal of the of the lining or covering that has built up on the internal surface of a barrel can restore the barrel for continued use. Removal of the of the lining or covering can re-expose the internal timber surface of the barrel for contact with liquid that is subsequently stored within the barrel. Thus, the useful life of the barrel can be extended. There are currently available techniques for restoring the internal surface of a wine or spirits barrel and these involve the use of a combination of steam and/or high pressure water applied to the internal surface. However, these techniques are not particularly effective in re-exposing the internal timber surface of the barrel and therefore they do not prolong the useful life of a barrel greatly.

Alternative techniques can involve dismantling the barrel to gain access to the internal surfaces so that the internal surfaces can be shaved, but the effort and cost of dismantling and properly reassembling the barrel means these techniques are relatively expensive and can result in problems with barrel integrity.

In the spirit industry, barrels (more typically known as casks) are used in the maturation of spirits such as whisky. The inside surface of these barrels is usually charred for the purpose of the addition of characteristics to the whiskey and the charred inside surfaces need to be rejuvenated after a period of use for continued use. For these barrels, the barrel is partially disassembled (the opposite ends or heads are removed) and mechanical methods are used to remove the upper timber layer of the internal surfaces before the cask is re-charred and re-assembled.

As a result of the relatively short life of the timber barrels used in the wine and spirit industries, manufacturers generally purchase new barrels each year at significant cost that must be passed onto the consumer. In addition to the cost, the global production of new barrels requires significant timber resources and any reduction in the amount of timber required would lead to obvious environmental benefits. It is estimated that in Australia alone, wine makers discard on average between 10% to 20% of their barrel inventory per year and currently, there are approximately 2600 Australian wine makers.

Australian patent 2018274885 in the name of the current applicant, discloses a method of in-situ sanding of internal surfaces of a barrel and apparatus for performing the sanding process, for the purpose of restoring the internal surfaces of a wine barrels by removing the lining or covering build-up. The method disclosed in patent 2018274885 involves inserting a quantity of cutting grit into a barrel and then rotating and pivoting the barrel to ensure that all internal surfaces of the barrel are sanded by the cutting grit. The apparatus in patent 2018274885 accepts a single barrel that is lifted into place into the apparatus and that is lifted off the apparatus once the sanding process is complete. The apparatus rotates a barrel about its axis by supporting the barrel on rotating rollers and uses roller point contact at each end of the barrel to clamp the barrel against axial movement. The point contact clamping is necessary so that the barrel can be retained in position when it is being rotated at any angle of inclination, but the clamping does not prevent the barrel from rotating. For pivoting, the apparatus has outer and inner frames with the inner frame being pivotable relative to the outer frame and the barrel is supported on the inner frame.

The apparatus and method of patent 2018274885 has successfully treated the internal surfaces of barrels to sand the internal surfaces so as to remove the built-up lining or covering and to re-expose the timber of the internal surfaces. However, the apparatus and method of patent 2018274885 has limitations in the high degree of manual handling of the barrel being treated. In addition, the use of external rollers on which the barrels are rotated introduces wear and reliability issues, given the dimensional variations in barrels, such as the dimensional differences in external fixtures (hoops, rivets) on barrels.

The present invention has been developed with the understanding that there is benefit in solutions that allow the internal surface of a timber barrel to be restored, rejuvenated or refurbished, in particular to remove all or a major part of any build-up, lining or covering over the internal surface that prevents access to the internal surface by a liquid product within the barrel. The present invention has been developed to provide an improved method and apparatus based on this understanding.

### SUMMARY OF INVENTION

According to the present invention there is provided a method of cleaning, rejuvenating or treating the internal surfaces of a timber barrel with an abrasive, the method involving;
1. inserting an abrasive into a timber barrel,
2. clamping the barrel with a clamp,
3. rotating the clamp to rotate the barrel about its axis,
4. tilting the axis of the barrel during rotation through at least about 20°, preferably 25-40%, to either side of horizontal.

The method of the invention advantageously operates without dismantling the barrel.

The method of the invention can involve inserting the abrasive into the barrel through a “bung” hole of the barrel and closing the bung hole before rotating and tilting the barrel. The use of the bung hole for inserting the abrasive is advantageous as it means that a separate opening does not need to be formed for the passage of abrasive. Obviously, barrels are intended to be watertight and so creating a new opening brings with it the need for proper sealing once the barrel is available for re-use, whereas use of the bung hole utilises a bung closure that will have been in place for several years during the use of the barrel and would have already proved its watertight capability.

According to the present invention there is also provided apparatus for cleaning, rejuvenating or treating the internal surfaces of a timber barrel with an abrasive, the apparatus comprising a clamping arrangement that includes at least one clamp for clamping the barrel, the clamp being rotatable to rotate the barrel about its axis. The clamping arrangement is operable to tilt the axis of the barrel during rotation through at least about 20°, preferably 25-40%, to either side of horizontal.

While each flat end of a barrel is often known as a “head”, the terminology “end” will be used throughout this specification. The ends of the barrel are flat and circular and fit within the ends of the staves that extend between the opposite barrel ends. The staves extend a small amount beyond the ends and thus form an upstanding perimeter lip which is otherwise known as a “chime”, and which term will be used herein after to describe this part of a barrel. However, because of the proximity of the chime to the end of a barrel, where reference is made herein to clamping the end or ends of a barrel, this is intended to cover clamping of the flat end or ends of the barrel, or clamping of the chime or chimes of the barrel, or clamping of both of the end or ends and the chime or chimes of the barrel.

The clamp of the clamping arrangement can clamp any part of the barrel. In some forms of the invention, the clamp clamps an outer surface of the barrel between opposite ends of the barrel. The clamping arrangement can include a plurality of clamps to clamp the outer surface of the barrel at two or more different positions, which can be two or more axially spaced positions. The clamping arrangement can for example, clamp the outer surface of the barrel at two positions equally spaced from either end of the barrel, such as equally spaced inboard of the opposite ends of the barrel. In other forms of the invention, the clamping arrangement clamps each end of the barrel, such as against the ends or heads of the barrel, or against the opposite chimes of the barrel.

The clamping arrangement can have a single clamp for clamping the barrel. Alternatively, the clamping arrangement can have two or more clamps for clamping the barrel. In some forms of the invention, the clamping arrangement includes a pair of clamps that are spaced apart to engage the barrel at or adjacent opposite ends of the barrel, either clamping the outer surface of the barrel, or clamping the opposite chimes or heads or ends of the barrel.

In some forms of the invention, the apparatus of the present invention has:
a. a processing station for receiving a barrel,
b. the station having a clamping arrangement for clamping the barrel, such as the outer surface of the barrel or each end of the barrel with one or more clamps,
c. the station being operable to rotate the clamp or clamps to rotate the barrel about its axis and to tilt the axis of the barrel during rotation through at least about 20°, preferably 25-40%, to either side of horizontal.

The apparatus of the invention also advantageously operates without dismantling the barrel.

The method and apparatus of the invention employs a clamp or clamps to rotate a barrel being cleaned, treated or rejuvenated. The clamp or clamps engage the barrel, such as at each end of the barrel and the clamp or clamps are rotatable to rotate the barrel about its axis, where the axis is the axis that extends through the opposite barrel ends, normally the longitudinal axis. Once the clamp or clamps have clamped the barrel, the barrel can be rotated without contact with other components.

That is, the only engagement with the barrel can be by the clamp or clamps. This differs from the arrangement of patent 2018274885, in which a barrel is clamped at each end and is rotated on rotating rollers so that contact points are required on the sides of the barrel as well as the barrel ends. In patent 2018274885, the clamps are not rotated. The function of the clamps is to locate the barrel as it is being rotated on the rollers. In the preferred embodiment of patent 2018274885, four rotating rollers are employed to roll against the sides of the barrel and two clamping rollers clamp opposite ends of the barrel, thus resulting in 6 roller contact points. This contrasts with the present invention in which, in the preferred embodiment, contact is only made at each end of the barrel and so only two contact points or lines or regions are required.

The barrel is clamped so that the barrel rotates generally about its longitudinal axis, but precise or exact axial rotation is not essential. Accordingly, small amounts of mis-concentricity or rotational wobble can be accommodated when the barrel is being rotated.

In the prototype of the apparatus of the present invention, the clamping arrangement includes a pair of clamps that engage the barrel ends. The engagement can be in any suitable manner. For example, clamps can engage the barrel ends generally at the centre of the barrel ends, for example so that the clamps engage substantially all of the barrel ends, or just a portion centrally of the barrel ends. However, in the prototype of the apparatus of the present invention the clamps engage the chimes of each barrel end and not the ends of the barrel inboard of the chimes. The advantage of engaging the chimes of the barrel ends is that staves that form the chimes are better suited to react the clamping load than the flat barrel ends given their bowed column construction and the metal hoop supports that extend about the staves, particularly the head hoop that that extends about the chimes.

The clamps can thus be guided into the correct clamping position by engagement of the chimes, such as the inside surface of the chimes. Indeed, typical chimes have an inclined or tapered inside surface that the clamps can slide against to substantially centre the clamps on or relative to the barrel ends. Again, precise or exact centring is not required.

The clamps have a clamping surface for clamping contact with the barrel ends, preferably the chimes as discussed earlier. The clamping surface can be of any suitable material. A suitable polymer material can form the clamping surface. The polymer material can be a resilient material that resiliently compresses when pressed or pushed against the barrel ends. The polymer material can be polyurethane or equivalent with around 90 douro hardness. Advantageously, in arrangements of the present invention where the clamps engage the chimes, the chimes can compress into the polymer to enhance the connection between the clamps and the chimes, reducing the pressure load required compared to a hard clamping surface with no compression capability or give.

It follows that in some forms of the invention, the clamps are circular and the outer diameter of the clamps at the edge or perimeter of the clamps is greater than the diameter of the chimes. Of course, the clamps can be square or otherwise shaped and still engage the chimes, or the ends. Any polymer material that forms the clamping surface can be applied across the full face of the clamps, or across a section of the clamps. In some forms of the invention, the entire face of the clamps is formed by or covered by a polymer material, whereas in other forms of the invention, a section of the face of the clamps is formed by or covered by a polymer material. In this latter form of the invention, a circular ring of may be applied to the clamps in the region of the clamps that engages the chimes, thus minimising the use of the polymer material just to the areas in which clamping engagement with a barrel occurs.

The clamps can have a backing member or board to which the polymer material attaches. The backing member or board can be circular and can be a metal plate. The backing member or board can extend beyond the periphery of the polymer material and so the backing member or board can have a greater diameter than the polymer material.

The clamps can engage the chime of a barrel end other than as described above. For example, the clamps can have projecting abutments, such as formed at the periphery of the clamps, to extend beyond the periphery and to overlie and engage a chime of a barrel end. The abutments can be fixed to the edge or rear of the clamps to project from the clamps for engagement with a chime.

The clamps can be rotated in any suitable manner. In some forms of the invention, a shaft extends from the back of the clamps and is driven to rotate by a suitable drive, such as an electric motor drive or a hydraulic drive. The drive can be a belt or chain drive, or a geared or sprocket drive. The shaft can be a stub shaft for example, or an elongate shaft. All that is required is that the clamps be driven to rotate. The rear construction of the clamps to achieve this is not important.

Only one of the clamps of the pair of clamps that clamp the opposite ends of a barrel needs to be driven. The other of the pair of clamps can be free to rotate upon rotation of the barrel. The other of the pair of clamps can also have a shaft that extends from the back of the clamp, but that shaft can be captured in a bearing to be free to rotate but without being driven to rotate. By driving only one of the clamps of the pair of clamps, synchronous drive of each end of the barrel is not required to be established. In some forms of the invention, one or both of the clamps may be attached to the drive by universal joints so that the or each clamp can adapt to any misalignment of the barrel when initially clamping the barrel or when the barrel is being rotated. A universal joint may connect between the clamp and the shaft that extends from the back of the clamp, or the universal joint may connect between the shaft that extends from the back of the clamp and the drive.

In other forms of the invention, both of the pair of clamps at each end of the barrel are driven to rotate the barrel.

The clamps can be driven to rotate the barrel, as well as to brake the barrel to slow or stop barrel rotation. Thus, the drive can increase and decrease the velocity of rotation. Alternatively, separate brakes can be provided to slow the velocity of rotation when required. These can be friction brakes that act on the barrel or on the clamps, or on shafts that extend from the clamps.

The clamps can engage opposite ends of a barrel in any suitable manner. In some forms of the invention, one or both of the pair of clamps has a retracted and an extended position, in which in the retracted position, the clamp or clamps is spaced from engagement with an end of a barrel and in the extended position, the clamp or clamps engages the end of a barrel. Where only one of the pair of clamps is movable between a retracted and an extended position, that clamp can push the barrel into clamping engagement with the other of the pair of clamps. The barrel can be mounted on wheels or rollers prior to clamping to facilitate movement of the barrel during clamping engagement. Alternatively, both clamps of the pair of clamps can be movable between a retracted and an extended position and the barrel can be placed between the pair of clamps prior to the clamps being moved to the extended position. The barrel may be shifted slightly as it is engaged by the pair of clamps if the barrel is not centred precisely between the pair of clamps.

The pair of clamps can be supported in a clamp supporting structure and for movement of the clamps between the retracted and an extended positions, the clamps may move relative to the clamp supporting structure, or the clamp supporting structure may move with the pair of clamps. Alternatively, the clamp supporting structure may comprise a first clamp supporting structure for supporting a first clamp of the pair of clamps and a second clamp supporting structure for supporting a second clamp of the pair of clamps and in arrangements in which only one of the pair of clamps is movable between retracted and an extended position, only the clamp supporting structure supporting that movable clamp is itself movable.

The clamp supporting structure may be movable vertically so that it can move to position the pair of clamps in a clamping position relative to a barrel from above or below the barrel. In some forms of the invention, the clamp supporting structure is initially positioned above the barrel and with a barrel in place ready for clamping, the clamp supporting structure is lowered to the clamping position and one or both of the pair of clamps is shifted into the extended position to clamp the barrel between the pair of clamps. Once clamped, the clamp supporting structure can be lifted with the clamped barrel to subsequently rotate and tilt the barrel.

The clamp supporting structure can include a square or rectangular frame with the clamps being mounted at opposite ends of the frame to oppose each other and for one or both of the clamps to extend and retract within the frame.

The clamps can clamp a barrel with the barrel in any suitable location. In some forms of the invention, the barrel can be located on a barrel rack of the kind that is regularly used in wineries and which supports the barrel in a position with the axis of the barrel between opposite ends being generally horizontal. The rack supports a bottom or underneath portion of the barrel, about an arc which can be about 20-25% of the outside periphery of the barrel. The rack can include a cradle for supporting the bottom or underneath portion of the barrel. Such racks often support a pair of barrels side by side with the axes of the barrels generally parallel. Such racks are also stackable, so that multiple pairs of barrels can be stacked vertically within sheds or warehouses on barrel racks.

In the above forms of the invention, the processing station of the apparatus, can be arranged to receive a barrel (or barrels) mounted on a barrel rack and the clamping arrangement can clamp each end of the barrel while the barrel is mounted on the barrel rack and then the clamped barrel can be lifted from the barrel rack for rotation and tilting. Alternatively, the processing station can include a lifting facility to lift the barrel from the support position within the barrel rack prior to clamping, so that the barrel is elevated above the support position on the barrel rack with the lifting facility facilitating any axial movement of the barrel relative to the barrel rack that is required as it is engaged and clamped by the clamps. The lifting facility can, for example, include one or more rollers for engaging the bottom or underneath portion of the barrel, or at the interface between the barrel and the lifting facility, so that once the barrel is lifted from support by the lifting facility, the one or more rollers allow the barrel to shift relative to the barrel rack as the barrel is clamped by the clamps. Where the pair of clamps comprises one axially movable and one axially stationary clamp, this allows the movable clamp to engage one end of a barrel and to push the barrel along the one or more rollers into engagement with the stationary clamp. Alternatively, if both clamps are movable, and if the barrel is not perfectly centred between the clamps, this allows one clamp to engage one end of the barrel first and to shift the barrel axially until the other clamp engages the other end of the barrel. The use of rollers means that the barrel is not forced to frictionally slide axially on the barrel rack, but rather, the rollers make any axial movement of the barrel relatively easy and without damaging the outside surface of the barrel.

The clamped barrel can be lifted for subsequent rotation and tilting, although of course rotation and/or tilting can commence as the barrel is lifted. Lifting can be by any suitable arrangement such as hydraulic strut or struts. Hydraulic struts can be attached directly to the pair of clamps of the clamping arrangement, or to a clamp supporting structure which supports the pair of clamps. Where a clamp supporting structure is employed, tilting of the barrel can be achieved by extending and retracting the struts. That is, the strut attached one of the pair of clamps can be lifted a greater or lesser amount than the strut attached to the other clamp of the pair of clamps so tilting the barrel. This requires a suitable connection between the clamps and the struts to allow the clamps to remain in clamping contact with the barrel ends as the barrel is tilted and may, for example, require a pivotable connection. In some arrangements, only one of the pair of clamps is connected to an extendable strut. By extending and retracting that strut to lift or lower the clamp to which the extendable strut is connected relative to the opposite clamp, the barrel can be tilted as required to either side of horizontal.

Alternatively, where the apparatus of the invention employs a clamp supporting structure, that structure may be connected to struts that lift and lower the structure and thus that lift and lower the clamping arrangement. In this form of the invention, the frame of the clamp supporting structure may be rotatable about an axis that extends laterally, most likely perpendicular, to the axis of a barrel clamped within the structure, and the strut arrangement, or any other suitable arrangement can be employed to rotate the frame about its axis to tilt the barrel clamped within the structure. For example, the clamp supporting structure may have front and rear ends and one or more vertical struts may connect to one of the ends to lift and lower the clamp supporting structure. A further strut may extend to connect to the frame of the clamp supporting structure on the opposite side of a rotation axis of the frame. This further strut can be actuated to tilt the frame of the clamp supporting structure about the axis and thus to tilt the barrel or barrels clamped within the frame.

It will be appreciated that in the above forms of the invention, the processing station of the apparatus can receive or accommodate a barrel rack on which one, or more likely two barrels are supported. The barrel rack with the one or two barrels can be placed or loaded into the processing station and thereafter, the clamping arrangement can be actuated for clamping each end of the barrel or barrels for lifting, rotating and tilting the barrel or barrels. Moreover, the apparatus according to the invention can return the barrel or barrels that have undergone the rotating and tilting movement back to the barrel rack for removal from the processing station. Loading and removal of a barrel rack to/from the processing station can be by any suitable arrangement, such as by forklift. This arrangement is particularly suited to mobile forms of the apparatus, such as where the apparatus is formed as a trailer, or a transportable module or modules, that can be driven for example, between wineries. However, barrels can also be delivered or fed to the apparatus by more manual arrangements, such as by hand-wheeled trolley, or more automated arrangements can be employed, such as conveyor systems. Conveyor systems might be employed in very large wineries that are regularly treating barrels by the method of the invention, or the treating service may be centralised in a wine area so that wineries deliver barrels to be treated to the central location which is permanently set up for the treatment process.

The apparatus of the invention may further include a second station at which an abrasive can be inserted into a barrel, such as through a bung hole of the barrel, to perform the sanding function when the barrel is rotated and tilted in the processing station. The second station can be an abrasive loading station (hereinafter a “loading station”) at which the barrel can be supported with the bung hole facing upwards, so that the abrasive can be inserted or added to the barrel through the bung hole. Alternatively, the abrasive can be added through a different opening in the barrel, such as an opening drilled through one end of the barrel, but use of the bung hole advantageously means that a further opening is not necessary to provide.

The loading station can be arranged to receive a barrel mounted on a barrel rack or a pair of barrels mounted or supported side by side on a barrel rack. Thus, advantageously, one barrel, or a pair of barrels, can be moved in a barrel rack by forklift from a storage position within a winery to the loading station where the bung can be removed from the bung hole of the or each barrel and the abrasive can be added to the barrel or barrels. Once the abrasive has been added, the bungs can be returned and the barrel or pair of barrels can be moved in the barrel rack by forklift from the loading station to the processing station. Advantageously, the barrels are not required to be removed from the barrel rack and movement of the barrels is facilitated by forklift within the barrel rack. Of course, movement of the barrel or pair of barrels can be other than by forklift, such as by conveyor for example, while the removal of the bung, the addition of abrasive and the return of the bung can be automated.

The loading station can include a supply of abrasive that can be fed into barrel. The abrasive could be hopper fed from above a barrel for example through a feed tube and nozzle. An overhead hopper can be periodically supplied with abrasive manually, or it can be fed automatically such as by a vacuum lift from an abrasive supply below the hopper. Feeding the abrasive from above the barrel allows the abrasive to be gravity fed.

The abrasive may be mixed with a liquid, water for example, to facilitate movement of the abrasive as a slurry. That mixture may be made prior to the abrasive being fed into the barrel so that a liquid/abrasive mixture is fed into the barrel rather than just abrasive. The mixture may be made in the hopper. The liquid can be water and the water can be hot water.

Alternatively, the abrasive and liquid may be separately fed into a barrel, to be mixed within the barrel, such as to form a slurry once inside the barrel.

The loading station can thus include a supply of abrasive and a source of liquid, water usually and preferably heated water, that either are combined or mixed prior to entry into the barrel, or which are combined or mixed once they are separately inserted or added into the barrel. The mixing may not occur properly until the barrel is treated at the processing station when it is rotated so that the abrasive and liquid within the barrel are then mixed together. Indeed, the abrasive and liquid may not form what would normally be considered a slurry. Rather, the abrasive and liquid may simply combine with the abrasive settling within the liquid when the barrel is stationary, i.e. not rotating or tilting, and moving with or within the liquid when the barrel is being rotated or tilted. The use of the liquid may only be to enhance the sanding effect of the abrasive against the internal surface of the barrel.

The loading station can be automated or controllable to set the amount of abrasive and liquid that is administered to the interior of the barrel. The personnel operating the loading station may be able to set the amounts of abrasive and liquid to be administered by suitable controls, and the differing amounts may be based on the extent to which the internal surface of the barrel needs to be sanded, which might be based on the years of service of the barrel before sanding treatment, or on the type of wine the barrel has been used to store and thus the likely level of tartrates that might have built up on the internal surface of the barrel. The amount of abrasive and liquid might also be dependent on the grade of abrasive and the amount of time the barrel is to be rotated and the speed of rotation. Still further, the amount of abrasive and liquid might also be dependent on the type or grade of timber that the barrel is formed from. Clearly there could be various factors that influence the amount of abrasive and liquid that is administered to the interior of the barrel and over time, expertise will be gained as to the optimum grade of abrasive and amount of abrasive and liquid that will achieve appropriate outcomes for particular types of barrels.

The apparatus of the invention may further include a third station which forms a discharge or washout station for discharge or removal from the barrel of the abrasive and liquid that was administered to the interior of the barrel prior to the barrel being rotated and tilted at the processing station, as well as to discharge or remove the debris that has been dislodged or removed from the internal surface of the barrel, usually the tartrates and timber shavings or particles that have been sanded from the internal surface. The third station (hereinafter a “washout station”) can support a barrel with the bung hole oriented downwardly so that discharge can take place through the bung hole once the bung has been removed. The washout station can have a bay or sump for collection of discharge from the barrel and the bay or sump can be operable to separate abrasive from the liquid and other debris, so that if appropriate, the abrasive can be reused.

The washout station can include a flushing liquid to assist the discharge of the abrasive and liquid administered to the interior of the barrel and the debris removed from the internal surface of the barrel. The flushing liquid can be hot or cold and low or high pressure water for example. The barrel can be flushed by low pressure water, or high pressure water, or low pressure followed by high pressure for example. The washout station can thus include a source for low and/or high pressure discharge into the interior of the barrel. The flushing liquid can assist the abrasive and debris to travel to the bung hole and can assist to dislodge and remove any abrasive or debris that becomes stuck to the internal surface of the barrel, such as in crevices in the internal surface. The flushing liquid can also be a cleaning liquid to clean the internal surface of the barrel, or a separate cleaning liquid can be employed. The cleaning liquid can also be administered to the interior of the barrel under low or high pressure.

The flushing liquid can be manually introduced, injected or discharged into the interior of the barrel with the operating personnel directing the liquid over the entire internal surface of the barrel for a predetermined period, such as until the liquid being discharged out of the barrel through the bung hole indicates that all abrasive and debris has been removed, ie the liquid being discharged out of the barrel is clear or clean. Alternatively, flushing can be automated with a bracket or manifold being attached to the barrel over or in proximity to the bung hole, with the flushing bracket or manifold being connected to a source of low and/or high pressure flushing liquid and with the ability to direct the flushing liquid over the entire internal surface of the barrel.

In some forms of the invention, the bracket or manifold attaches to the barrel over or in proximity to the bung hole but leaves the bung hole at least partially open to allow escape or discharge from the barrel of abrasive, liquid and debris through the bung hole. In this respect, a typical wine barrel bung hole has a diameter of approximately 40 mm (although some are 50 mm) and in some forms of the invention, a flushing bracket or manifold includes a hollow shaft or tube that extends through the bung hole for delivering flushing liquid into the interior of the barrel and the hollow shaft or tube has an external diameter of approximately 20 mm, so that there remains a gap or ring between the inside edge of the bung hole and the facing outer surface of the shaft or tube of about 10 mm in depth for the escape or discharge from the barrel of abrasive, liquid and debris through the bung hole.

It is to be appreciated that reference to the bung hole above in relation to flushing liquid used at the washout station is made because at present, use of the bung hole for the introduction of flushing liquid into a barrel is considered to be the most appropriate entry point for the flushing liquid, as well as being the most appropriate discharge point from within a barrel for abrasive, liquid and debris. It is to be appreciated however, that in future, it may be that an alternative opening is employed for introduction of flushing liquid and for discharge of abrasive, liquid and debris and that different openings may be used for these activities. Or, it may be that the bung hole may be used for one of these activities and that a different opening may be used for the other of these activities.

To assist discharge from the barrel, particularly discharge of abrasive and debris, the washout station can also support a barrel in a manner that allows the barrel to be gently rocked or vibrated in order to promote travel of abrasive and debris towards the bung hole. In some forms of the invention, the washout station can support the barrel on feet that can be rocked back and forward to similarly rock the barrel back and forward. In some forms of the invention, the feet can be rollers so that when a barrel is placed within the washout station, it can be supported on the rollers and can be rotated on the rollers to rotate the bung hole from an upward facing position in which abrasive and liquid can be administered to the interior of the barrel, to a downward facing position in which the abrasive and liquid can be discharged from the interior of the barrel. The rollers can allow the barrel to rotate about its axis, but not along its axis.

The feet may be raised into engagement with the underneath surface of the barrel once the barrel has been loaded into the washout station, or loading of the barrel into the washout station may bring the underneath surface of the barrel into engagement with the feet. In embodiments of the invention in which the barrel is supported in a barrel rack in the processing, loading and washout stations of the apparatus of the invention, the barrel rack is placed within the washout station and the barrel can be lifted out of engagement with the barrel rack as the barrel rack is placed within the washout station and the feet engage and support the underneath surface of the barrel. If the feet are rollers, once the barrel is supported on the rollers, the bung can be removed and the barrel can be rotated, manually or automatically through about 180° to position the bung hole in the downward facing, discharge position. Once in that discharge position, and with the bung removed, liquid and possibly some abrasive and debris will start to flow out of the bung hole. However, as will be apparent from the above discussion, not all of the abrasive, liquid and debris will necessarily flow out of the barrel and so gentle rocking or vibration of the barrel can promote travel of abrasive and debris towards and out of the bung hole. The administration of low and/or high pressure flushing liquid into the interior of the barrel can also be performed with the barrel being rocked or vibrated.

The second or loading station has been described above as being separate to the third or washout station although it should be appreciated that the loading station and the washout station can be the same stations so that the abrasive and liquid can be administered to the interior of the barrel at the same station that the abrasive, liquid and debris are removed from the barrel. Consequently, the loading and washout stations can form a combined loading and washout station. As will be apparent from the above discussion, such a combined loading and washout station can support barrels on rollers so that a barrel can be rotated to have the bung hole facing upwards for loading of abrasive into the barrel and later to have the bung hole facing downwards for discharging the abrasive, liquid and debris from the barrel.

Also, the processing station can be combined with the loading and washout stations so that the abrasive and liquid can be administered to the interior of the barrel at the same station that the barrel is rotated and tilted and at the same station as where the abrasive, liquid and debris are removed from the barrel. Put simply, one or more of the stations can be combined.

The method of the invention can therefore involve placing a barrel in a loading station and inserting an abrasive into a timber barrel through an opening in the barrel, such as a bung hole of the barrel, closing the opening, shifting the barrel to a processing station and at that station,
clamping each end of the barrel with clamps,
rotating the clamps to rotate the barrel about its axis, and
tilting the axis of the barrel during rotation through at least about 20°, preferably 25-40%, to either side of horizontal.

The method of the invention can therefore further involve, after the barrel has been rotated and tilted, shifting the barrel to a washout station and at that station,
introducing a flushing liquid into the interior of the barrel so that the flushing liquid flows over the entire internal surface of the barrel,
orienting the barrel so that a discharge opening of the barrel, such as the bung hole of the barrel, faces downwards,
allowing the flushing liquid to flow out of the discharge opening.

The method of the invention can therefore further involve rocking or vibrating the barrel when the flushing liquid is inside the barrel and/or while the flushing liquid is discharging from the barrel.

It will be appreciated that many features of the invention described above are described as apparatus features, but these features could equally be method features and so the previous discussion should be understood to apply equally to either the apparatus of the invention or the method of the invention.

The present invention also provides an abrasive for use in a method or apparatus for rejuvenating or treating the internal surfaces of a timber barrel the abrasive comprising cutting media in the form of granular garnet or garnet gravel in the particle size range generally of about 1 mm-8 mm, more preferably 2 mm-5 mm. This granular garnet can be used in the method or apparatus as described and claimed herein.

The abrasive may include additional material or media to act as ballast when the abrasive is inside a barrel and the barrel is rotating. In some forms of the invention, this additional material can be of larger particle size to the cutting media described above and provides downward force on the cutting media to enhance or accelerate the process of treating/sanding the inside surface of the barrel. This additional material may be another inert stone or bespoke ceramic particles, typically spherical or triangular.

The granular garnet should be inert with respect to the pH of wine and preferably should be hard and sharp. Suitable qualities include a bulk density of about 2100 kg/m3±3%, specific gravity 4.0±3%, grain shape—sub-rounded to sub-angular. The mineral composition can be 98% minimum garnet, 2% maximum feldspar and quartz and maximum 0.25% biotite and others.

### BRIEF DESCRIPTION OF DRAWINGS

In order that the invention may be more fully understood, some embodiments will now be described with reference to the figures in which:

FIG. 1 is a side view of a trailer in accordance with one embodiment of the invention for cleaning, rejuvenating or treating the internal surfaces of timber wine barrels.

FIG. 2 is a side view of the loading and washout station of the trailer of FIG. 1.

FIG. 3 is an end view of the loading and washout station of the trailer of FIG. 1.

FIG. 4 is a side view illustrating one barrel in the processing station of the trailer of FIG. 1.

FIG. 5 is a plan view of the trailer of FIG. 1.

FIGS. 6 to 10 show a barrel being loaded into the processing station of the trailer of FIG. 1 and subsequently lifted, rotated and tilted.

FIG. 11 shows a barrel in the loading and washout station of the trailer of FIG. 1 being rocked.

FIG. 12 is a schematic view of a treatment facility in accordance with an alternative embodiment of the invention for rejuvenating or treating the internal surfaces of timber wine barrels.

### DETAILED DESCRIPTION

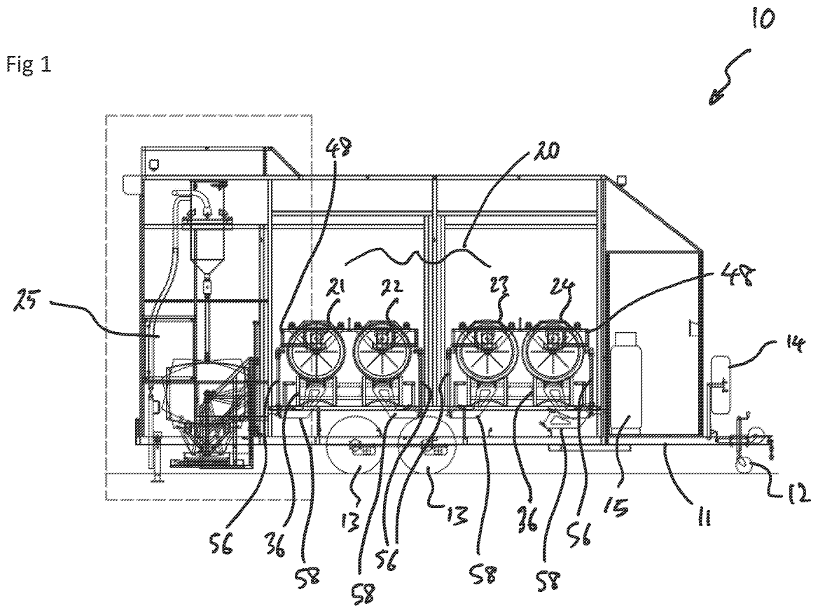

FIG. 1 is a side view of a trailer which has been assembled to include apparatus in accordance with the invention for cleaning, rejuvenating or treating the internal surfaces of timber wine barrels. The trailer 10 includes a chassis 11, that has a jockey wheel 12 at a front end, wheels 13 mid-way along the chassis 11, a spare wheel 14 and a gas cylinder 15. The trailer 10 is shown open, although it would be fully enclosed for travelling purposes with hinged doors or roller doors that can be opened and shut, so that the apparatus mounted within the trailer can be accessed when the trailer is stationary.

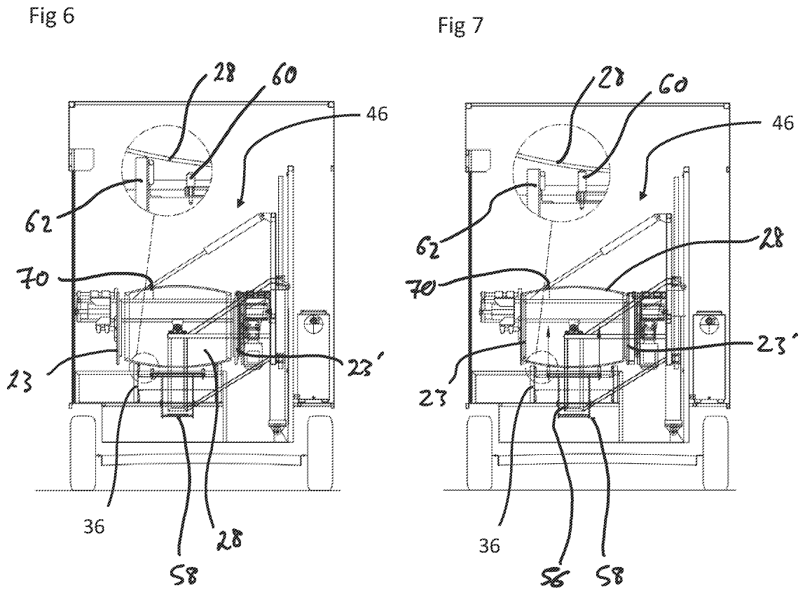

The trailer 10 includes a first area or processing station 20 within which a clamping arrangement in disposed. In FIG. 1, the clamping arrangement comprises four individual barrel clamps 21 to 24, each of which is arranged for engaging the chime at the head or end of a barrel. As will be seen later in this description (see FIG. 5 for example), the barrel clamps 21 to 24 are one of a pair of clamps that are positioned opposite each other for engaging the opposite heads or ends of an individual barrel. FIG. 5 shows that the clamps comprise pairs of clamps 21,21′, 22,22′, 23,23′ and 24,24′. The processing station 20 of the trailer 10 thus has capacity to receive and clamp the opposite ends of four barrels at one time.

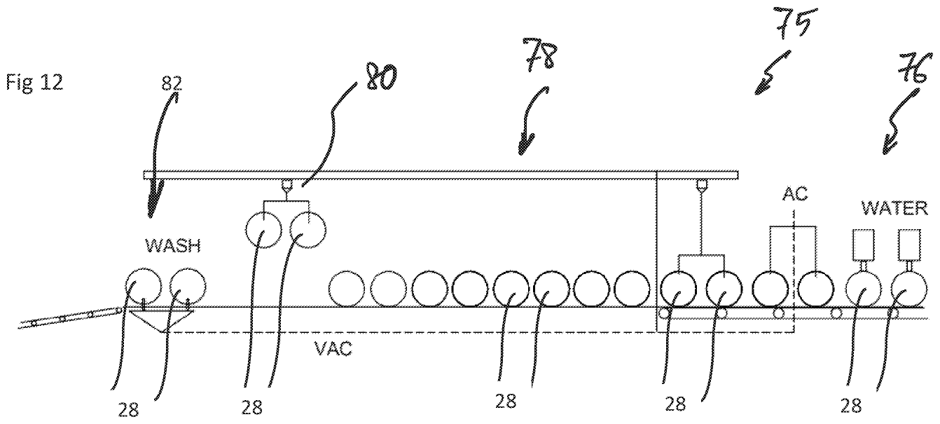

The trailer 10 further includes a second station 25 in which a pair of barrels that are to be treated in the processing station 20, can be loaded with an abrasive. The second station 25 is thus alternatively termed a “loading station”. The loading station 25 can also constitute a “washout” station in which a barrel that has been treated in the processing station 20 can be emptied of abrasive and any debris that has been removed from the internal surface of the barrel, and washed. The washout station can be a separate and third station of the invention, although in the trailer 10, the loading station and washout station are both provided in the second station 25. FIG. 12 will be discussed later, but shows a different arrangement in which the washout station is a separate station to the loading station.

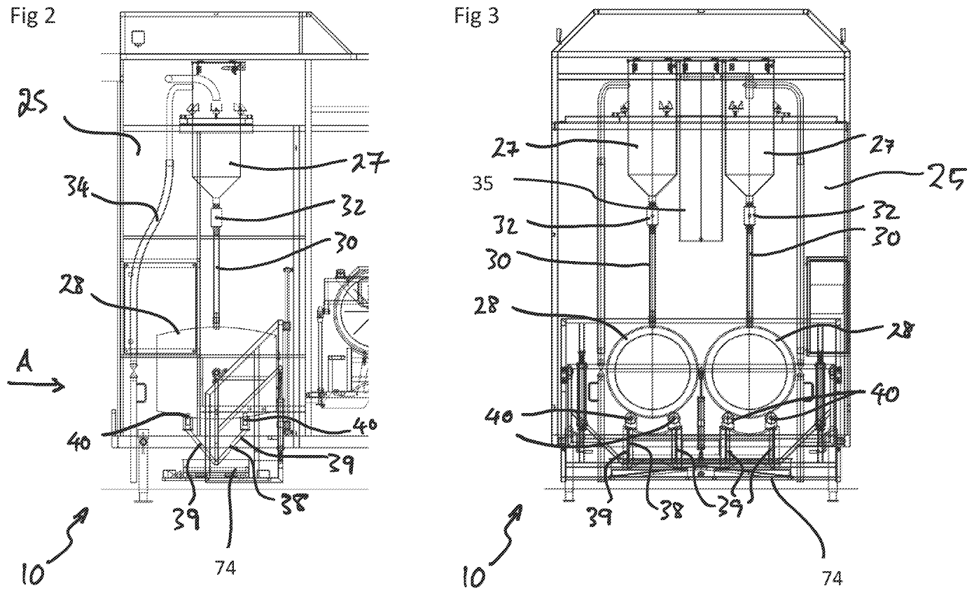

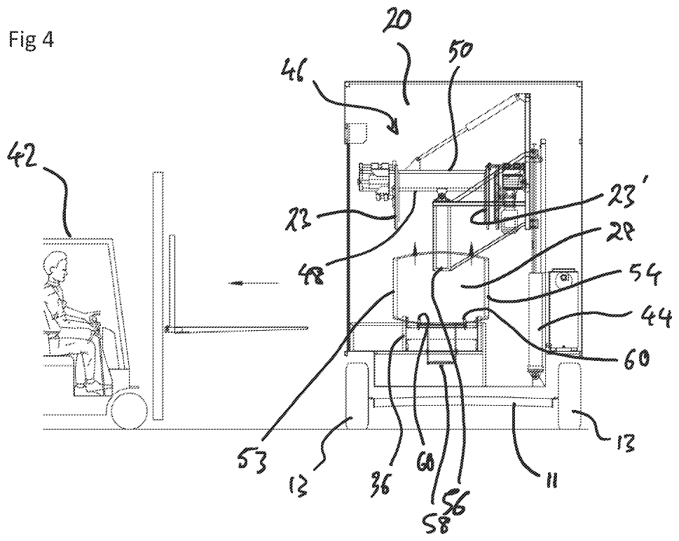

A timber barrel can be treated in the trailer 10 to remove unwanted lining or covering that has formed or has built up over the internal surface of the barrel, firstly by inserting an abrasive into the barrel and in relation to the trailer 10, this occurs within the loading station 25. The loading station 25 is shown in FIGS. 2 and 3 in both side and end view respectively. In FIGS. 2 and 3, a pair of hoppers 27 is elevated above the pair of barrels 28 and the hoppers 27 each include a feed tube 30 that includes a delivery valve 32 so that abrasive which is contained within the hopper 27 can be fed through the delivery tube 30 and into the barrel 28. Conveniently, feed into the barrels 28 can be through the bung hole of the barrel which is a hole that all wine barrels have. The bung hole is normally closed by a bung, but for the purpose of introducing abrasive into the barrel 28, the bung is removed.

To feed the hopper 27, a further feed tube 34 extends upwardly and into connection with the upper end of the hopper 27 and the feed tube 34 feeds from a supply of abrasive (not shown) to replenish the hopper 27 from time to time.

Liquid is also fed into the barrels 28 to mix with the abrasive and FIG. 3 shows a container 35 of water that feeds into the hoppers 27 so that the feed into the barrels 28 is an abrasive/water mixture or slurry. This feed can be automated so that the same amount of abrasive/water mixture is introduced into each barrel, or it can be manual and the amount determined by an operator.

A barrel is loaded into the loading station 25 on a barrel rack, which is not visible in FIGS. 2 and 3. The barrel racks are shown in FIG. 1 in the processing station 20 by the reference numerals 36. The barrel racks 36 shown in FIG. 1 are racks that include a pair of cradles side-by-side, which each support a single barrel. The barrel racks 36 can take a standard form that are used in wineries around the world.

In FIGS. 2 and 3, a pair of barrels 28 has been loaded by forklift into the loading station 25 in the direction shown by the arrow A. The pair of barrels 28 has been loaded into the loading station 25 supported on a barrel rack 36 and as the barrel racks 36 are loaded into the loading station 25 they are lowered, so that the barrels 28 supported on the barrel racks 36 are lifted from support on cradles of the barrel racks 36 by engagement with a support structure 38 that has four legs 39 and each of the legs 39 includes a roller 40 at its upper free or distal end. Accordingly, within the loading station 25, each barrel 28 is supported on either side of its axis by a pair of rollers 40 that allows the barrel 28 to roll about its axis. This is permitted by the orientation of the rollers, so that the rollers 40 do not allow linear axial movement of the barrels in the direction A, but rather, only allow rotational movement about the barrel axis. This ability for the barrels 28 to rotate about their axis in the loading station 25 is important so that the bung hole of each barrel can be rotated to an upwardly facing position for connection with the hopper feed tube 30, and can be subsequently rotated to a downwardly facing position, so that after treatment of the barrels 28, the abrasive within the barrels 28 and any liquid and debris, can be removed through the downwardly facing bung hole and the inside of the barrels can be washed out with liquid injected through the bung hole.

Once the pair of barrels 28 in the loading station 25 have received a charge of abrasive mixture from the hopper 27, the feed tube 30 can be disconnected from the barrels 28. Liquid can be introduced into the interior of the barrels 28 with the abrasive in a slurry as discussed above, although in alternative arrangements, liquid, such as water, can be introduced separately.

Once the abrasive/water mixture has been introduced into the barrels 28, the bungs can be reinserted into the bung holes, and the barrel rack on which the barrels 28 were delivered into the loading station 25, can be lifted, again by forklift, to 25. In an automated arrangement, removal and reinsertion of the bungs into the bung holes can be automated, as can introduction of the abrasive/water mixture into the barrels. The barrels can then be removed from the loading station an automated arrangement, such as by autonomous vehicles or conveyor.

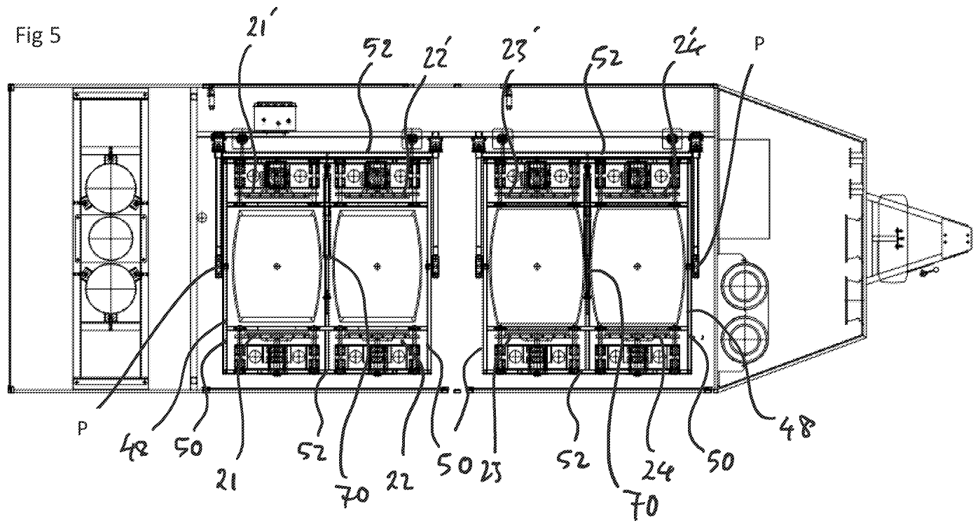

The barrels 28 and the barrel racks 36 on which they are mounted, can now be placed into the processing station 20 and to allow this placement, the clamps 21,21′ to 24,24′ are lifted upwardly and out of the way. FIG. 4 illustrates schematically a forklift 42 that has delivered a pair of barrels 28 into the processing station 20 on a barrel rack 36 with the clamps 23,23′ shown elevated above the barrel 28. The clamps 21,21′ to 24,24′ are part of a clamping assembly 46 that will be described in more detail later herein, and the clamping assembly 46 includes a frame 48 to which the clamps (including the clamps 23,23′) are attached and that can be lifted and lowered. In FIG. 4, the forklift is retreating away from the trailer 10 having delivered the barrels 28 to the processing station 20.

FIG. 4 also shows the hydraulic mechanism by which the clamps 21,21′ to 24,24′ are raised along with the drive arrangements that are employed to drive the clamps 21,21′ to 24,24′ to rotate. The arrangement shown in FIG. 4 only shows the clamps 23,23′ but the arrangement applies to each of the clamps 21,21′ to 24,24′. As shown in FIGS. 1 and 5, the clamps 21,21′ and 22,22′ are connected to one of the frames 48, while the clamps 23,23′ and 24,24′ are connected to the other of the frames 48. A separate hydraulic mechanism is attached to the separate frames 48, but their operation is the same.

The lifting arrangement includes a hydraulic strut 44 (FIG. 4) that raises and lowers the frame 48 that includes the clamps 23,23′. The frame 48 is square or rectangular (see also FIGS. 1 and 5) and has a pair of side rails 50 and a pair of end rails 52. The clamps 23,23′ are connected to the end rails 52 and the end rail 52 that connects to the clamp 23′ is connected to the strut 44 and is lifted up and down by the strut 44. Lifting and lowering of the end rail 52 by the strut 44 lifts and lowers the entire frame 48. FIGS. 1 and 4 show the frames 48 of the clamping assembly 46 in lowered and raised positions respectively. In the FIG. 4 position, the frame is raised is for loading of the barrel rack 36 and barrels 28 into the processing station 20 and once loaded, the forklift 42 can reverse away from the trailer 10. The frames 48 can then be lowered to the FIG. 1 position whereafter the clamps 23,23′ can be brought to a position adjacent the opposite barrel ends 53 and 54 for subsequently clamping the barrel ends.

As the frames 48 of the clamping assembly 46 are lowered from the FIG. 4 position, the barrels 28 remain supported on the barrel rack 36 within the processing station 20, however the clamping assembly 46 includes an actuating frame 56 (FIG. 4) that engages barrel supports 58 (FIG. 1) as the frames 48 are lowered, to lift the supports 58 into engagement with the underneath surface of the barrels 28 so as to slightly lift the barrels 28 off the barrel rack 36. The barrel supports 58 are pivotal about an axis so that as they are engaged on one side of the axis by the actuating frame 56 the opposite side lifts into lifting engagement with the barrels 28. In that lifted position, the barrel racks 36 no longer support or contact the barrels 28, so that the barrels are supported only by the barrel supports 58. The barrel supports 58 include rollers 60 that allow the barrels 28 to shift axially forward and back so that when the barrel ends 53 and 54 are engaged by the clamps 23,23′, if the barrels 28 are not perfectly centred between the clamps 23,23′ (and non-perfect centring will normally be the case), the barrels 28 can shift slightly axially without dragging resistance that would occur if the barrels 28 were still supported on the barrel rack 36.

As described earlier herein, the clamps 21,21′ to 24,24′ are circular (see FIG. 1) and of a diameter greater than the diameter of the chimes of the barrels 28, so that the periphery of the clamps 21,21′ to 24,24′ clamps against the chimes. The clamping surface of the clamps can be of any suitable material and a suitable polymer material can form the clamping surface that allows the chimes to compress into the polymer to enhance the connection between the clamps and the chimes.

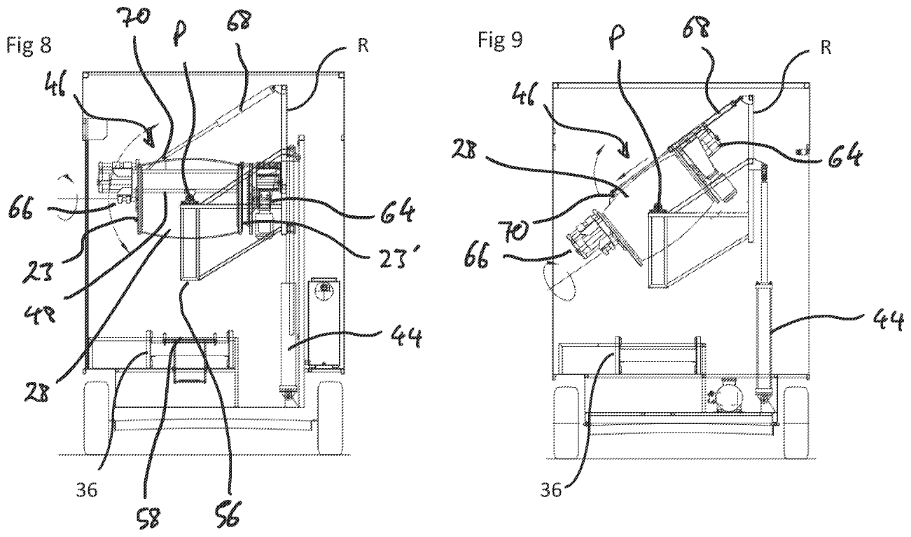

FIGS. 6 and 7 show the arrangement of FIG. 4 but with the clamping assembly 46 lowered, so that in FIG. 6, the clamps 23,23′ are closely adjacent to the barrel ends 53 and 54, but are not clamped against those ends, while in FIG. 7, the clamps 23,23′ have been shifted into clamping engagement with the barrels ends 53 and 54. FIGS. 6 and 7 also clearly show the change in support of the barrels 28 between the barrel rack 36 and the rollers 60 of the barrel supports 58. In the broken line insert of FIG. 6, the underneath surface of the barrels 28 is supported on an upper end of a post 62 of the barrel rack 36 and the roller 60 is spaced from the underneath surface of the barrel 28. In contrast, in FIG. 7, the broken line insert shows that the roller 60 is now engaged with the underneath surface of the barrel 28 and the post 62 is no longer in contact with the barrel 28. In the FIG. 7 arrangement, the barrel 28 is now free to move slightly axially when the clamps 23,23′ engage the opposite ends of the barrel 28 to accommodate centring misalignment of the barrel 28 between the clamps 23,23′.

In the FIG. 7 configuration, the barrel 28 is clamped and thus can now be lifted for rotation and tilting. Lifting is necessary in the illustrated embodiment so that tilting can take place. FIG. 8 shows the clamping assembly 46 and the clamped barrel 28 lifted upwardly so that the barrel 28 is lifted away from the barrel supports 58. In the elevated position, and optionally as the elevation is taking place, the barrel 28 can be rotated. A hydraulic motor 64 drives the clamp 23′ which, by the clamping connection of the clamps 23,23′ with the barrel 28, causes the barrel 28 to rotate about its axis as shown by the rotation arrows shown in FIGS. 8 and 9. The opposite clamp 23 rotates freely within a bearing arrangement 66, so that rotation of the barrel 28 is by drive of the clamp 23′ only.

Rotation of the barrel 28 with the abrasive and liquid inside the barrel 28 applies a sanding effect against the internal surfaces of the barrel 28 so that any lining or covering, such as a tartrate layer deposited on the internal surface of the barrel 28, is removed. However, simply rotating the barrel 28 about its axis will not necessarily remove a lining or covering that has formed a layer on or over the inside surfaces of the barrel ends 53 and 54. Accordingly, the invention provides for tilting barrel 28 as it is rotated and FIGS. 9 and 10 show respectively, tilting in a first direction followed by tilting in a second and opposite direction. It can be seen from FIGS. 9 and 10, that the tilting movement occurs about a central pivot point P, which is the point at which the frame 48 of the clamping assembly 46 is pivotably connected to the actuating frame 56 at point P. The frame 48 is not shown in FIGS. 9 and 10 but can be seen in FIG. 8. It is the actuating frame 56 that is lifted and lowered on the hydraulic strut 44, and the frame 48 that is tilted relative to the actuating frame 56. Tilting is by extension and retraction of the hydraulic strut 68 that connects between the rod R and the connection point 70 (see FIG. 5 as well as FIGS. 6 to 10) and that tilts the frame 48 relative to the actuating frame 56. The angle of tilt can be appreciated from FIGS. 9 and 10 and in the examples illustrated, is in the order of about 40° from horizontal. As shown in FIGS. 9 and 10, as the tilting of the barrel 28 takes place, the barrel 28 continues to be rotated about its axis.

In testing conducted to date, it is only necessary to tilt the barrel in each direction once, so that for example, from the horizontal axis position of FIG. 8, the barrel 28 can be tilted in the first direction shown in FIG. 9 once, and after a predetermined time, the barrel can be tilted in the reverse direction to the FIG. 10 position and after a predetermined time, the barrel can be returned to the horizontal position of FIG. 8. In that position, the barrel can be lowered back to the FIG. 7 position and as the barrel is lowered, the actuating frame 56 will engage the barrel support 58 so that the support 58 lifts and the barrel 28 is lowered onto the rollers 60. The barrel clamps 23,23′ can then be released from either end of the barrel 28 and the clamping assembly 46 can then be lifted again, so that the barrel supports 58 shift downwardly or away from the underneath of the barrel 28 and lower the barrel 28 back onto the barrel rack 36. A forklift 42 can then be used to lift the barrel rack 36 and the barrels 28 from the processing station 20. The barrel rack 36 and the barrels 28 can be returned to the loading station 25 and as the barrel rack 36 is lowered into the loading station 25, the barrels 28 will be supported on the rollers 40 of the support structure 38 as shown in FIG. 3.

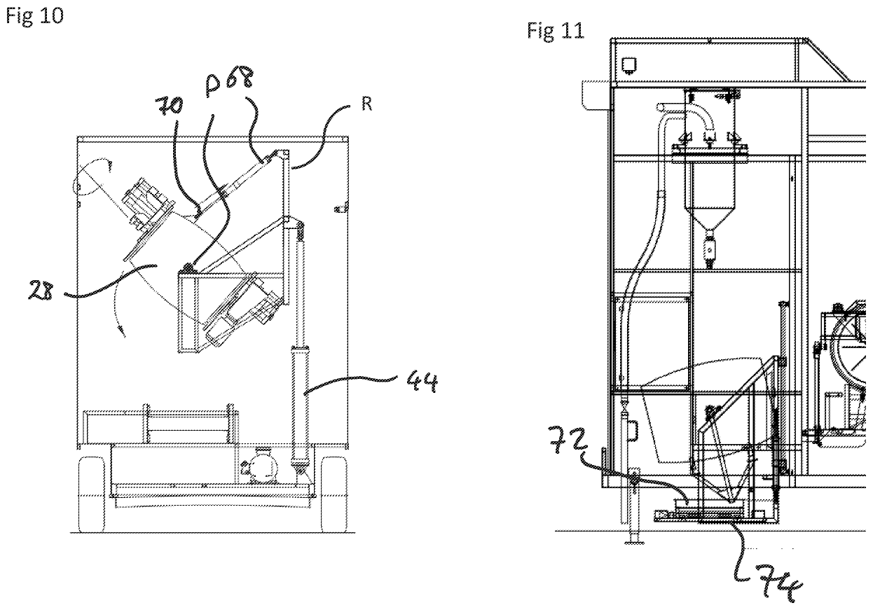

With the barrel rack 36 and the barrels 28 returned to the loading station 25, and with the barrels 28 supported on the rollers 40, the barrels 28 can be rotated from whatever orientation about their axis they are delivered to the loading station 25 in so that the bung hole faces upwardly and the bung can be removed. Once removed, the barrels can be rotated so that the bung hole faces downwardly and immediately liquid and abrasive, and the debris which has been removed from the internal surfaces of the barrel 28 will start to flow out of the bung hole. However, it is not expected that all of the abrasive and debris will flow out simply by orienting the bung hole downwardly, and so the support structure 38 is arranged for rocking the barrels 28 back and forward and one direction of rocking is shown in FIG. 11. By rocking the barrel back and forward, the abrasive and debris will tend to be shifted or agitated towards the middle of the barrel and thus out through the bung hole. The bung hole will usually be located in a low point of the barrel when the barrel is horizontal so that the bung hole becomes a drain hole to which liquid, abrasive and debris will naturally flow or move towards. The support structure 38 is arranged to oscillate forward and back along the track 72 and by that oscillating movement, the barrel rocks up and down from end to end, enhancing movement particularly of the abrasive and debris to the bung hole.

The rocking movement on its own is not expected to fully remove all abrasive and debris from within the barrel. Accordingly, while the barrel is supported by the support structure 38 (FIG. 3), a hose can be inserted into the bung hole, so that washing liquid, typically warm water, can be injected into the barrel to spray over all of the internal surfaces of the barrel and to cause all of the abrasive and debris to travel to the bung hole and out of the barrel 28. This can be a manual process whereby an operator inserts a hose into the barrel and directs the nozzle of the hose to spray liquid against all surfaces of the interior of the barrel to flush out the abrasive and debris. Alternatively, the hose can be affixed to a bracket which itself is connected over the bung hole and the bracket can be arranged to ensure that spray is directed across all internal surfaces of the barrel. In each case, the intention is that the nozzle or hose end that extends into the barrel only takes up a portion of the cross-sectional area of the bung hole, so that there is room for abrasive and debris to be flushed out of the barrel even as the hose and/or nozzle is inserted into the barrel through the bung hole. Bung holes can typically have a diameter of 40 mm or 50 mm and so a 20 mm diameter hose will leave on average a 10 mm gap about the hose for abrasive and debris to flow out of the bung hole while the hose is delivering flushing liquid into the barrel.

The output from the barrel can flow into a basin 74 (see FIGS. 2, 3 and 11) that liquid, abrasive and debris collect in after being flushed out of the barrel 28. This allows the abrasive to be collected for later reuse. The basin 74 can have a filter or screen that allows liquid to flow through so that only solids are collected on top of the filter or screen.

Once the barrel 28 has been fully washed out to the extent that all of the abrasive and debris is considered to be removed from the barrel, the forklift 42 can return to pick up the barrel rack 36 and the two barrels 28 for return for reuse within a winery. Two new barrels can be loaded into the loading station 25 on a barrel rack 36 and the process of treatment explained above repeated.

It will be appreciated that the processing station 20 of the trailer 10 can accommodate two barrel racks and thus four barrels, whereas the loading station 25 can accommodate just the one barrel rack and therefore two barrels. Of course additional loading stations can be added, or the capacity of the loading station can be increased so that a greater number of barrels can be loaded with abrasive and subsequently washed out than in the trailer 10. However, the trailer 10 as illustrated meets the required regulations for road travel and so redesign of the trailer would be required if a greater capacity in the loading station 25 were to be provided.

The trailer 10 has been developed as a means of making the present invention mobile so that an operator of the trailer 10 can move between wineries as required. However, the present invention is not limited to a mobile form of operation and in an alternative embodiment, a fixed facility can be created utilising the same invention as utilised in the trailer 10. FIG. 12 illustrates one rudimentary form of such a fixed installation in which the wine barrels 28 are fed from one end of the facility through to the opposite end by conveyor. The facility could be a linear facility, or a circular facility whereby in a circular facility, the barrels 28 are added to and removed from the facility generally at the same point, whereas in the linear facility, barrels 28 would be added from one side or end and removed from the opposite side or end.

FIG. 12 thus shows a treatment facility 75 having a loading station 76 at which point barrels 28 are loaded with an abrasive and water, and a rotating and tilting station 78 at which point barrels are fed to a clamping assembly 80 for clamping and lifting, and then for rotating and tilting. The clamping assembly 80 can operate in the same manner as described in relation to the clamping assembly 46 of the trailer 10. After a sufficient period of rotation and tilting, the barrels 28 clamped in the clamping assembly 80 can be lowered and fed to a wash out station 82, whereafter the barrels 28 can be removed and returned to barrel racks.

In the FIG. 12 arrangement, the barrels 28 could be conveyed thoughout the facility 75 supported on barrel racks, being lifted from the barrel racks when required, although in the illustrated form of the facility 75, the barrels 28 are removed from the barrel racks and placed on a conveyor to move through the stations 76, 80 and 82.

Where any or all of the terms “comprise”, “comprises”, “comprised” or “comprising” are used in this specification (including the claims) they are to be interpreted as specifying the presence of the stated features, integers, steps or components, but not precluding the presence of one or more other features, integers, steps or components.

Those skilled in the art will appreciate that the invention described herein is susceptible to variations and modifications other than those specifically described. It is understood that the invention includes all such variations and modifications which fall within the spirit and scope of the present invention.

1. Apparatus for cleaning, rejuvenating or treating the internal surfaces of a timber barrel with an abrasive, the apparatus comprising a clamping arrangement that includes at least one clamp for clamping the barrel, the clamp being rotatable to rotate the barrel about its axis and the clamping arrangement being operable to tilt the axis of the barrel during rotation through at least about 20°, preferably 25-40%, to either side of horizontal.

2. Apparatus according to claim 1, the clamp being operable to clamp an outer surface of the barrel between opposite ends of the barrel.

3. Apparatus according to claim 1, the clamping arrangement including a plurality of clamps to clamp the outer surface of the barrel at two or more different positions.

4. Apparatus according to claim 1, the clamping arrangement including a pair of clamps clamp for clamping each end of the barrel.

5. Apparatus according to claim 4, the clamping arrangement including a pair of clamps having a clamping surface for clamping contact with the barrel ends, the clamping surface including a resilient polymer material that resiliently compresses when pressed or pushed against the barrel ends.

6. Apparatus according to claim 4, the clamps being circular and the outer diameter of the clamps at the edge or perimeter of the clamps is greater than the diameter of chimes of the of the barrel ends.

7. Apparatus according to claim 4, the clamps having a shaft that extends from the back of each clamp and at least one of which is driven to rotate.

8. Apparatus according to claim 4, one or both of the clamps being attached to the drive by a universal joint.

9. Apparatus according to claim 7, one of the pair of clamps being free to rotate within a bearing upon rotation of the barrel.

10. Apparatus according to claim 4, one or both of the pair of clamps having a retracted and an extended position, in which in the retracted position, the clamp is spaced from engagement with an end of a barrel and in the extended position, the clamp engages the end of a barrel.

11. Apparatus according to claim 1, a barrel or a pair of barrels being supported side-by-side on a barrel rack and the clamping arrangement including at least one clamp for clamping the barrel or barrels, each clamp being rotatable to rotate the barrel or barrels about its axis and the clamping arrangement being operable to tilt the axis of the barrel or barrels during rotation through at least about 20°, preferably 25-40%, to either side of horizontal.

12. Apparatus according to claim 11, the apparatus including a lifting facility to lift the barrel or barrels from being supported within the barrel rack, so that the barrel or barrels are elevated above the support position on the barrel rack prior to clamping and the lifting facility including rollers for engaging the bottom or underneath portion of the barrel or barrels, the rollers allowing the barrel or barrels to shift axially.

13. Apparatus according to claim 1, the clamp or clamps being supported in a clamp supporting structure and the clamp supporting structure being movable vertically so that it can move to position the clamp or clamps in a clamping position relative to a barrel from above or below the barrel.

14. Apparatus according to claim 13, the clamp supporting structure including a square or rectangular frame with a pair of clamps being mounted at opposite ends of the frame to oppose each other and to extend and retract within the frame.

15. Apparatus according to claim 14, the frame of the clamp supporting structure being rotatable about an axis that extends laterally, preferably perpendicular, to the axis of the barrel or barrels clamped within the structure, and the frame being drivable about the axis of rotation to tilt the barrel or barrels clamped within the clamp supporting structure.

16. Apparatus according to claim 1, further including a loading station at which an abrasive can be inserted into a barrel through an opening in the barrel, such as bung hole of the barrel.

17. Apparatus according to claim 1, further including a washout station forming a discharge or washout station for introducing a liquid into the barrel to assist the discharge from within the barrel of the abrasive and liquid administered to the interior of the barrel and the debris removed from the internal surface of the barrel.

18. Apparatus according to claim 17, the washout station including a support that supports a barrel in a manner that allows the barrel to be gently rocked or vibrated in order to promote travel of abrasive and debris towards the bung hole.

19. A method of cleaning, rejuvenating or treating the internal surfaces of a timber barrel with an abrasive, the method involving;
a. inserting an abrasive into a timber barrel,
b. clamping each end of the barrel with clamps,
c. rotating the clamps to rotate the barrel about its axis,
d. tilting the axis of the barrel during rotation through at least about 20°, preferably 25-40%, to either side of horizontal.

20. A method according to claim 19, liquid being inserted into the barrel with the abrasive to form an abrasive/liquid slurry.

21. A method according to claim 19, the barrel being rotated with a generally horizontal axis for a first period, and then being tilted in a first direction to one side of horizontal and rotated in the tilted position for a second period, and then being tilted in a second direction to the other or opposite side of horizontal and rotated in the tilted position for a third period, and then being returned to a generally horizontal axis.

22. An abrasive for use in a method or apparatus for rejuvenating or treating the internal surfaces of a timber barrel the abrasive comprising granular garnet or garnet gravel in the size range generally of about 1 mm-8 mm, more preferably 2 mm-5 mm and/or having a bulk density of about 2100 kg/m3±3%, specific gravity 4.0±3%, grain shape—sub-rounded to sub-angular.

23. An abrasive according to claim 22, the abrasive comprising a mineral composition of 98% minimum garnet, 2% maximum feldspar and quartz and maximum 0.25% biotite and others.
